(19) United States
(12) Patent Application Publication
(10) Pub. No.: US 2008/0203680 A1
(43) Pub. Date: Aug. 28, 2008

(54) COLLET-TYPE CHUCK

(75) Inventors: Heinrich Peter Rohm, Sontheim (DE); Eugen Hangleiter, Hermaringen (DE)

Correspondence Address: K.F. ROSS P.C., 5683 RIVERDALE AVENUE, SUITE 203 BOX 900, BRONX, NY, 10471-0900, US

(73) Assignee: ROHM GmbH

(21) Appl. No.: 12/036,453

(22) Filed: Feb. 25, 2008

(30) Foreign Application Priority Data
Feb. 26, 2007 (DE) 102007009578.5

(51) Int. Cl. B23B 31/20

(52) U.S. Cl. 279/74

(57) ABSTRACT

A tool or workpiece has a mounting collar open axially outward, formed with a radially inwardly directed angled flank, and having a radial outer surface of noncircular cross-sectional shape. A chuck has a body formed with an axially forwardly open socket shaped to receive the collar with the axes generally coaxial and having an inner surface of a noncircular cross-sectional shape substantially complementary to the shape of the collar outer surface. A plurality of jaws axially fixed in the socket have radially movable ends engageable inside the collar and each formed with a radially inwardly and axially outwardly directed face. A cam having a face centered on the axis is engageable with the jaw front ends such that axial rearward shifting of the cam presses the jaw front ends outward and thereby presses the jaw faces against the collar flank to lock the collar in the socket.

### FIELD OF THE INVENTION

The present invention relates to a collet-type chuck. More particularly this invention concerns such a chuck that grips a mounting collar of a tool, workpiece, or the like.

### BACKGROUND OF THE INVENTION

A standard collet chuck for attachment to a mounting collar of a tool or workpiece has a body formed centered on an axis with a forwardly open socket shaped to coaxially receive the mounting collar. A collet inside the body has a plurality of jaws with front ends that project axially forward into the collar. The jaws can rock to move the front ends radially outward to engage behind an axially forwardly directed shoulder flank of the collar and thereby lock the collar to the chuck body. An axially displaceable cam inside the body has a head engageable with inner faces of the front ends of the jaws so that, when displaced axially rearward, the cam spreads the front ends of the jaws to press them radially outward against the mounting collar and, when displaced axially forward, allows these front ends to shift inward to release the mounting collar.

A chuck of this type is known from DE 41 38 974 for example where the chuck head is connected to an actuating rod and movable from a release position in which the gripper jaws do not engage the mounting collar to a holding position in which the gripper jaws engage and lock in the mounting collar, which is customarily fitted by a loader device to the chuck. This type of tool-holding collet has been tried and proven in practice and standardized according to DIN 69893. However, there is a problem in that there is always some play that adversely affects the accuracy of the chuck position as well as reproducibility.

### OBJECTS OF THE INVENTION

It is therefore an object of the present invention to provide an improved collet-type chuck.

Another object is the provision of such an improved collet-type chuck that overcomes the above-given disadvantages, in particular that is particularly accurate with respect to the positioning of the mounting collar in the gripped position.

### SUMMARY OF THE INVENTION

Thus according to the invention a tool or workpiece has a mounting collar generally centered on an axis, open axially outward, formed with a radially inwardly directed angled flank, and having a radial outer surface of noncircular cross-sectional shape. A chuck has a body centered on and rotatable about an axis and formed with an axially forwardly open socket shaped to receive the collar with the axes generally coaxial and having an inner surface of a noncircular cross-sectional shape substantially complementary to the shape of the collar outer surface. A plurality of jaws axially fixed in the socket have radially movable ends engageable inside the collar and each formed with a radially inwardly and axially outwardly directed face. A cam having a face centered on the axis is engageable with the jaw front ends such that axial rearward shifting of the cam presses the jaw front ends outward and thereby presses the jaw faces against the collar flank to lock the collar in the socket.

This embodiment has the advantage that the surfaces that engage the mounting collar as well as the socket are aligned so that they perfectly fit each other and, in particular, rotation around the longitudinal axis of the spindle relative to the chuck is prevented by the non-circular shape of the outer surface of the mounting collar and the inner surface of the socket.

It is particularly preferred if the outer cross-sectional surface of the hollow shaft is a polygon, preferably with rounded corners, since this shape allows a particularly simple relative angular alignment. This object is also aided in that the facet or surface between adjacent corners is radially outwardly convex so that the cross-sectional shape of the outer surface of the mounting collar forms an epitrochoid and that sharp corners and edges are avoided.

With respect to low expense for manufacturing, it is also sufficient if the polygon has three corners.

In addition, within the framework of the invention, as customary with mounting collars, it is envisaged that the mounting collar tapers axially outward toward its free end and the socket is shaped complementarily, so that self-centering and a solid clamping are achieved, if, due to the pull-down effect produced by the gripper flanks, the mounting collar is clamped in the socket. The inner surface of the socket flares complementarily axially inward, that is toward the tool or workpiece having the mounting collar.

In order to simplify changing of the mounting collar normally done by a loader, it is envisaged within the framework of the invention that holding arms are attached to the spindle and have radially elastically deflectable clamping tongues that extend parallel to the gripper jaws and that have complementarily inclined holding faces that abut the gripper flanks when the clamping tongues are in the rest position. In order to simplify the mounting of the chuck, the gripper jaws are joined to form a segmented collet that is held by rubber bumpers in a groove of the spindle.

### BRIEF DESCRIPTION OF THE DRAWING

The above and other objects, features, and advantages will become more readily apparent from the following description, reference being made to the accompanying drawing in which:

FIG. 1 is a longitudinal section through the end of the chuck gripping a mounting collar; and

FIG. 2 is an axial end view of the end of the chuck with the socket and mounting collar shaped as epitrochoids.

### SPECIFIC DESCRIPTION

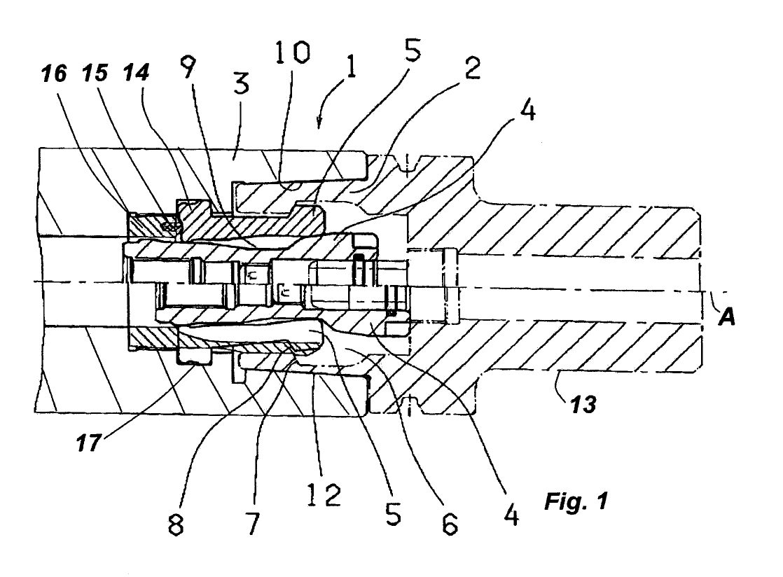

As seen in FIG. 1 a chuck 1 like that of this invention, which is known from the art and described in DE 41 38 974, for example, so that it does not need to be described more closely here, is shown in FIG. 1 and has an end centered on an axis A fitting with a mounting collar 2 of a tubular tool shank or shaft forming a chuck body 3. A cam or chuck head 4 shiftable along an axis A in a spindle 3 is connected with an unillustrated actuating rod that also can move axially in the spindle 3, so that the chuck head 4 can be moved from a release position shown below the axis A in FIG. 1 to a clamping position shown above the axis A and in which collet gripper jaws 5 engage the mounting collar 2. A radially and axially inwardly directed angled frustoconical gripper flank 7 formed in an interior 6 of the collar 2 is engaged by complementary, that is radially and axially outwardly directed, gripper flanks 8 of the gripper jaws 5 when the chuck head 4 in FIG. 1 is slid axially to the left, so that the gripper jaws 5 are cammed radially outward from a groove 9 of the chuck head 4 to shift the mounting collar 2 axially outward, to the left, because of the angle of the gripper flanks 7 and the inclined flank surfaces 8. To this end the gripper jaws 5 are extend axially inward from and are integral with a ring 14 set in a radially inwardly open groove 17 of the chuck body 3. A ring 16 with rubber bumpers 15 holds the ring 14 in the groove 17.

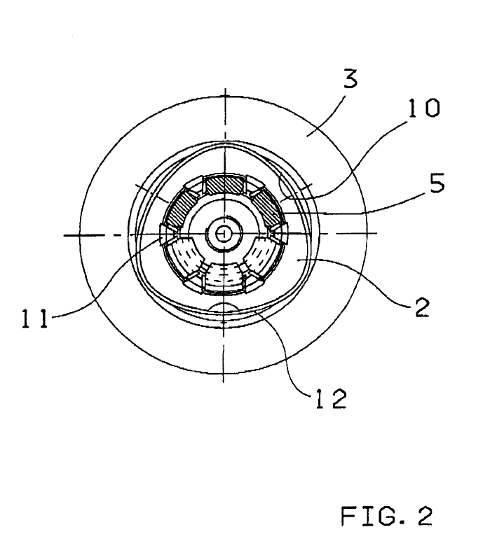

In order to eliminate play, an inner surface 10 of the socket of the chuck body 3 and an outer surface 12 of the mounting collar 3, are of generally complementary cross-sectional shape, here a polygon with rounded corners. Surfaces or facets of the outer surface 12 between its rounded corners are radially outwardly convex and surfaces or facet of the inner surface 10 between the respective rounded corners are radially inwardly concave such that the collar 2 fits somewhat snugly at the corners with, as shown in FIG. 2, radial clearance therebetween.

In the embodiment illustrated in the drawing, the polygon has three corners. In addition the mounting collar tapers axially outward, that is toward the left in FIG. 1, toward its outer end and the socket 10 is complementarily flared. The mounting-collar inner surface 10 can be described as a polygonal taper.

In order to simplify fitting of the socket 10 with the mounting collar 2, the spindle 3 has holding arms that are formed with radially elastically deflectable tongues 11 that extend parallel to the gripper jaws and that have inclined holding faces complementary to the gripper flanks 7 and that engage the gripper flanks 7 in a rest position of the tongues 11.

We claim:

1. In combination:
a tool or workpiece having a mounting collar generally centered on an axis, open axially outward, formed with a radially inwardly directed angled flank, and having a radial outer surface of noncircular cross-sectional shape;
a chuck body centered on and rotatable about an axis and formed with an axially forwardly open socket shaped to receive the collar with the axes generally coaxial and having an inner surface of a noncircular cross-sectional shape substantially complementary to the shape of the collar outer surface;
a plurality of jaws axially anchored in the socket and having radially movable ends engageable inside the collar and each formed with a radially inwardly and axially outwardly directed face; and
a cam having a face centered on the axis and engageable with the jaw front ends such that axial rearward shifting of the cam presses the jaw front ends outward and thereby presses the jaw faces against the collar flank to lock the collar in the socket.

2. The combination defined in claim 1 wherein the chuck-body outer surface fits snugly with the mounting-collar inner surface.

3. The combination defined in claim 1 wherein the surfaces are generally polygonal in cross section.

4. The combination defined in claim 3 wherein the surfaces have rounded corners.

5. The combination defined in claim 4 wherein the surfaces each have only three such corners.

6. The combination defined in claim 4 wherein the surfaces have between the corners outwardly convex facets.

7. The combination defined in claim 3 wherein the cross-sectional shapes are epitrochoids.

8. The combination defined in claim 1 wherein the mounting-collar outer surface tapers axially outward toward the chuck body and the chuck-body inner surfaces flares complementarily axially inwardly toward the tool or workpiece.

9. The combination defined in claim 1 wherein the jaws are all unitarily formed with a ring generally centered on an axis, whereby the jaws and ring form a collet.

10. The combination defined in claim 9 wherein the chuck body is formed with a radially open groove in which the ring is set.
